(19) United States
(12) Patent Application Publication
(10) Pub. No.: US 2015/0251885 A1
(43) Pub. Date: Sep. 10, 2015

(54) VARIABLE FORK ATTACHMENT FOR HI-LO VEHICLE

(71) Applicant: SIGNS365, Shelby Twp., MI (US)

(72) Inventor: Mark Phillips, SR., Shelby Twp., MI (US)

(21) Appl. No.: 14/641,476

(22) Filed: Mar. 9, 2015

Related U.S. Application Data
(60) Provisional application No. 61/949,362, filed on Mar. 7, 2014.

(51) Int. Cl. B66F 9/14

(52) U.S. Cl. CPC B66F 9/144

(57) ABSTRACT

A lift attachment for a hi-lo vehicle is disclosed. The lift attachment includes a universal bracket member configured to attach to the hi-lo vehicle and a plurality of parallel, elongated forks that are connected to and extending outward from the universal bracket. At least one of the forks has a lateral position that is selectively adjustable.

### CROSS-REFERENCE TO RELATED APPLICATIONS

This application claims the benefit of U.S. Provisional Application No. 61/949,362 filed on Mar. 7, 2014. The entire disclosure of the above application is incorporated herein by reference.

### FIELD

The present disclosure relates to hi-lo vehicles, also commonly referred to as fork-lifts.

### BACKGROUND

Hi-lo vehicles are commonly used to move various things from one place to another. Most commonly, hi-lo vehicles are used to place or remove items, especially heavy items, on/from shelves and other supporting structures that are elevated from the ground. Hi-lo vehicles are used in many different settings, such as for example warehouse and industrial settings, to move materials, products and other things from place to place. Most commonly, the things to be moved are stored on pallets, which are designed and configured to be engaged and moved by a hi-lo vehicle.

Traditional hi-lo vehicles include a motorized vehicle portion and a lift portion that is vertically movable up and down by an operator of the hi-lo vehicle. The lift portion commonly includes two elongated “forks” that extend outward from the front of the hi-lo vehicle. The forks are normally flat on their upper and lower surfaces (or at least their upper surfaces), which enables the forks to effectively slide into pallets and to best support items with flat bottoms, such as boxes.

The inventors have recognized a need for an alternative arrangement for the lift portion of a hi-lo vehicle.

### SUMMARY

A lift attachment for a hi-lo vehicle is disclosed. The lift attachment includes a universal bracket member configured to attach to the hi-lo vehicle and a plurality of parallel, elongated forks that are connected to and extending outward from the universal bracket. At least one of the forks has a lateral position that is selectively adjustable. In one embodiment, the fork(s) is adjustable via an adjustable fork bracket that is slidable along an axle.

In alternative embodiments, the lift attachment includes at least three forks and/or the forks are cylindrical in shape.

### DRAWINGS

FIG. 1 is a perspective view of a hi-lo vehicle having a lift attachment according to an embodiment of the invention.

FIG. 2 is a perspective view of the lift attachment shown in FIG. 1.

FIG. 3 is a front view of the lift attachment shown in FIGS. 1 and 2.

FIG. 4 is a side view of the lift attachment shown in FIGS. 1-3.

FIG. 5 is a top view of the lift attachment shown in FIGS. 1-4.

FIG. 6 is a perspective view of the hi-lo vehicle shown in FIG. 1, further illustrating its use for transporting rolls of material.

### DETAILED DESCRIPTION

Certain types of materials are manufactured into long heavy rolls, such as carpeting, fabric, plastic sheeting, paper, and other similar flexible planar materials (collectively, “rolls” or “rolls of material”). Typically, these types of materials are rolled around a circular “core”, commonly made from a heavy cardboard or hard plastic material. The rolls of material are used in various manufacturing facilities to manufacture products from the material. These heavy rolls of material must be moved, transported and manipulated in and around the manufacturing facilities. Moreover, it is often desirable to stack and store rolls of material on shelves and other areas and support mechanisms that are elevated from the ground, most typically in a manner such that at least one open “end” of a roll is exposed. The most common approach to moving rolls of material in and around manufacturing facilities and other locations is by one or more workers physically lifting and moving the rolls. However, because the rolls are heavy and elongated, it is an awkward and difficult task to manipulate and move rolls of material. Moreover, usually it takes two workers to move a single roll of material at a time. The inventive hi-lo attachment mechanism described below is adapted to enable a traditional hi-lo vehicle to be used to effectively and efficiently move rolls of material.

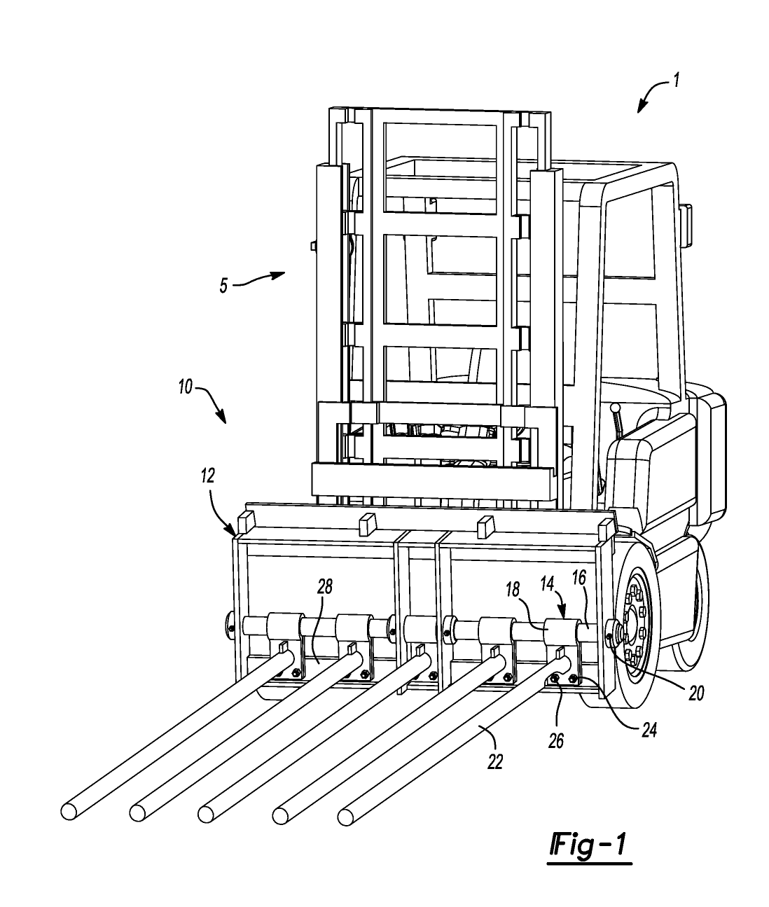

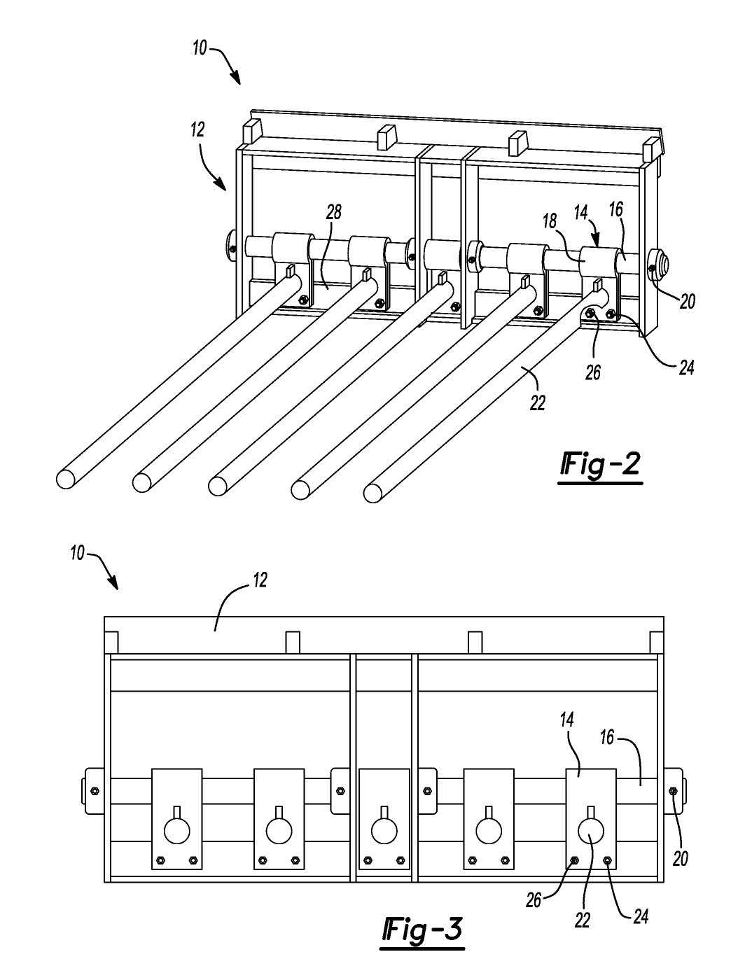

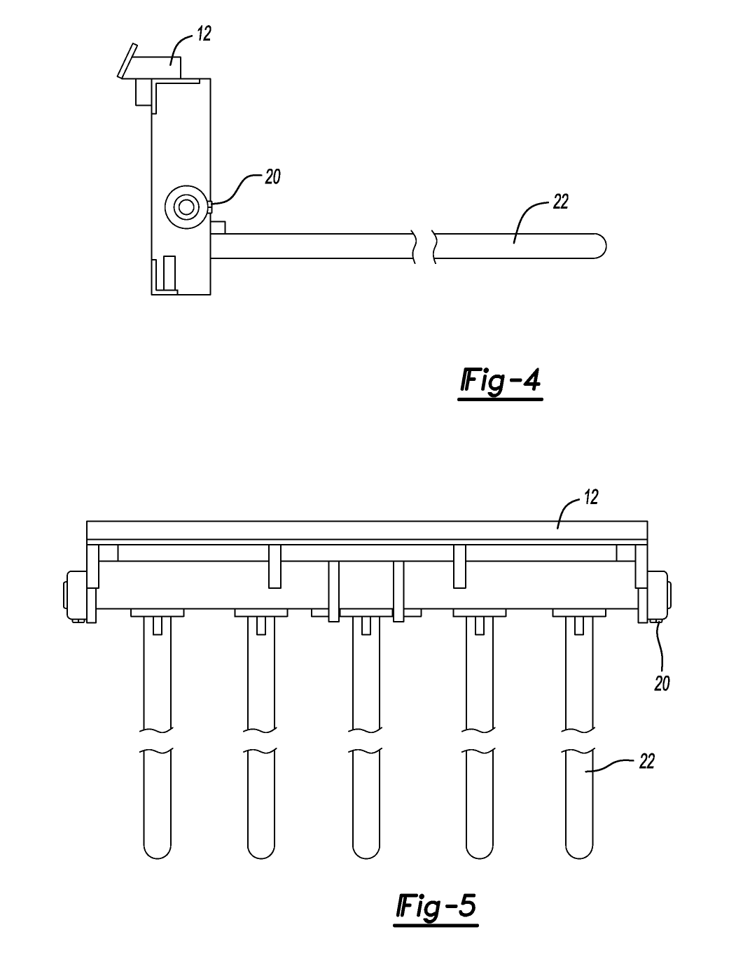

FIG. 1 is a perspective view of a hi-lo vehicle 1. The hi-lo vehicle has a vehicle portion 3 and a lift portion 5. The lift portion 5 includes a lift attachment 10, which is configured to be attachable to the lift portion 5 of a conventional hi-lo vehicle. FIGS. 2-5 illustrate various views of the lift attachment 10 (FIG. 2 is a perspective view, FIG. 3 is a front view, FIG. 4 is a side view, and FIG. 5 is a top view).

The lift attachment 10 is now described with reference to FIGS. 1-5, wherein like elements are identified by like reference numerals. The lift attachment 10 includes a universal bracket 12, which is used to connect the lift attachment 10 to the lift portion 5 of the hi-lo vehicle 1. The lift attachment 10 further includes a removable axle or barrel 16, which is rotatably secured by a locking nut 20. A plurality of elongated forks 22 are slidably attached to barrel 16 via fork brackets 14. A stop bar 28 is included on the universal bracket 12 to provide support and stability to the forks 22. The figures illustrate the lift attachment 10 having 5 forks 22, but more or less than 5 forks 22 can be employed depending on the desired application. Though not necessary, the forks 22 are preferably cylindrical in shape.

Fork brackets 14 include a hollow cylindrical portion 18 that slidably engages with the axle or barrel 16. Fork brackets 14 also may include screw nuts 24 and 26, which can be selectively tightened or loosened, which enables an operator to adjust the forks 22 to different lateral positions along the axle or barrel 16 and/or modify the number of forks 22 that are utilized. Other mechanisms for adjusting the lateral position of fork brackets 14 along axle 16 may be employed.

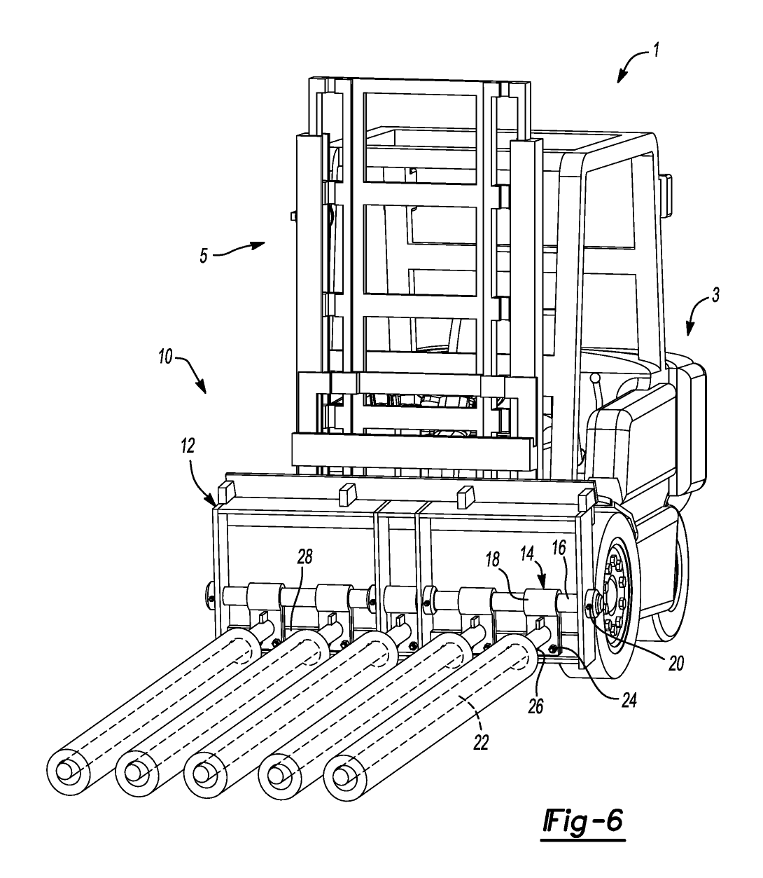

FIG. 6 illustrates the ho-li vehicle 1 having the above-described lift attachment 10, wherein rolls of material are being carried by the forks 22.

The embodiments described herein are the purpose of illustration only. They should not be construed as limiting. Various modifications to the embodiments described herein could be employed and still be within the spirit and scope of the invention.

What is claimed is:

1. An lift attachment for a hi-lo vehicle, comprising:
a universal bracket member configured to attach to the hi-lo vehicle; and
a plurality of parallel, elongated forks that are connected to and extending outward from the universal bracket;
wherein at least one of the forks has a lateral position that is selectively adjustable.

2. The lift attachment of claim 1, further comprising:
an axle connected laterally to the universal bracket; and
a plurality of fork brackets, each corresponding to one of the plurality of forks, that connect the corresponding fork to the axle;
wherein the fork brackets are selectively slidable along the axle.

3. The lift attachment of claim 2, wherein each of the fork brackets further includes at least one screw nut that is configured to adjust the tightness of the connection of the fork bracket to the axle.

4. The lift attachment of claim 1, wherein the forks are cylindrical in shape.

5. The lift attachment of claim 1, wherein the plurality of forks comprise at least three forks.

6. The lift attachment of claim 1, wherein the axle comprises multiple segments.

7. The lift attachment of claim 1, further comprising a stop bar positioned behind the plurality of forks and configured to prevent the forks from being pushed inward toward the hi-lo vehicle.

8. A hi-lo vehicle comprising:
a vehicle portion;
a lift portion connected to the vehicle portion; and
a lift attachment connected to the lift portion, wherein the lift attachment includes:
a universal bracket member configured to attach to the lift portion; and
a plurality of parallel, elongated forks that are connected to and extending outward from the universal bracket;
wherein at least one of the forks has a lateral position that is selectively adjustable.

9. The hi-lo vehicle of claim 8, further comprising:
an axle connected laterally to the universal bracket; and
a plurality of fork brackets, each corresponding to one of the plurality of forks, that connect the corresponding fork to the axle;
wherein the fork brackets are selectively slidable along the axle.

10. The hi-lo vehicle of claim 9, wherein each of the fork brackets further includes at least one screw nut that is configured to adjust the tightness of the connection of the fork bracket to the axle.

11. The hi-lo vehicle of claim 8, wherein the forks are cylindrical in shape.

12. The hi-lo vehicle of claim 8, wherein the plurality of forks comprise at least three forks.

13. The hi-lo vehicle of claim 8, wherein the axle comprises multiple segments.

14. The hi-lo vehicle of claim 8, further comprising a stop bar positioned behind the plurality of forks and configured to prevent the forks from being pushed inward toward the hi-lo vehicle.
